(19) United States
(12) Patent Application Publication
(10) Pub. No.: US 2003/0071909 A1
(43) Pub. Date: Apr. 17, 2003

(54) Generating images of objects at different focal lengths

(76) Inventor: Geoffrey W. Peters, Hillsboro, OR (US)

Correspondence Address: Timothy N. Trop, TROP, PRUNER & HU, P.C., 8554 KATY FWY, STE 100, HOUSTON, TX, 77024-1805, US

(21) Appl. No.: 09/975,527

(22) Filed: Oct. 11, 2001

(51) Int. Cl. H04N 5/232

(52) U.S. Cl. 348/349

(57) ABSTRACT

An imaging device may capture images over at least two different focal lengths. The captured images may then be combined to create a composite image that depicts in-focus objects at different distances from the imaging device.

### BACKGROUND

This invention relates generally to digital imaging including digital imaging associated with digital cameras and devices that utilize digital imaging technology including digital microscopes.

Conventionally, a single imaging device may focus on one object in its field of view. In many cases, the user can adjust the focus to bring an object at a particular focal distance into sharp focus in the resulting image.

Often times, items of interest may be at different distances from the digital imaging device. It is generally not possible to capture an in-focus image of objects at different focal lengths.

As a result, when objects are at different focal lengths from the imaging device, some of the objects may be in focus while other objects may be out of focus. The user can control which object is in focus by controlling the focal length of the imaging device. However, it would be desirable to enable objects at different focal lengths from the imaging device to be captured in focus.

### BRIEF DESCRIPTION OF THE DRAWINGS

FIG. 1 is a schematic depiction of one embodiment of the present invention;

FIG. 2 is a flow chart for software in accordance with one embodiment of the present invention; and

FIG. 3 is a depiction of hardware in accordance with one embodiment of the present invention.

### DETAILED DESCRIPTION

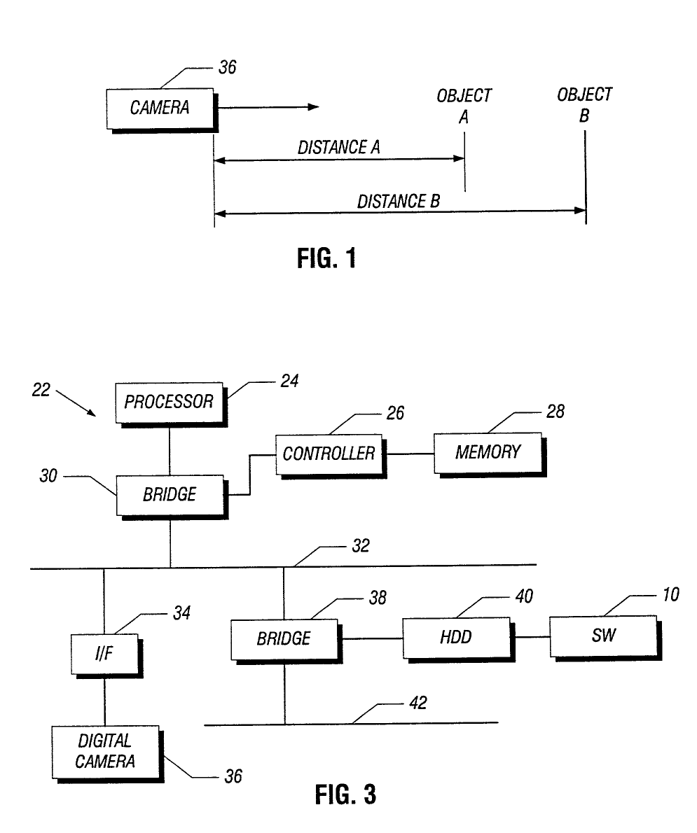

Referring to FIG. 1, a digital imaging device 36 such as a camera may be at different distances from two objects A and B to be captured in the resulting digital image. For example, the object A may be at a focal length A from the imaging device 36 and the object B may be at a focal length B from the imaging device 36. As a result, a single imaging device 36 may be unable to capture images of both objects A and B that are completely in focus. Instead, the user may adjust the focus on the imaging device 36 to place one of the objects A or B in focus. The other object, which is not placed in focus, then appears somewhat blurred in the resulting captured image.

In accordance with one embodiment of the present invention, the imaging device 36 may be focused over at least two different focal lengths so as to capture both objects A and B in focus. The images of the objects A and B may then be combined to create a composite image in which both objects are in proper focus. In some embodiments, the imaging device 36 may automatically scan through a number of focal lengths resulting in an image with objects in focus at multiple focal lengths. In other embodiments, the imaging device 36 may be manually focused at any number of different focal lengths by the user.

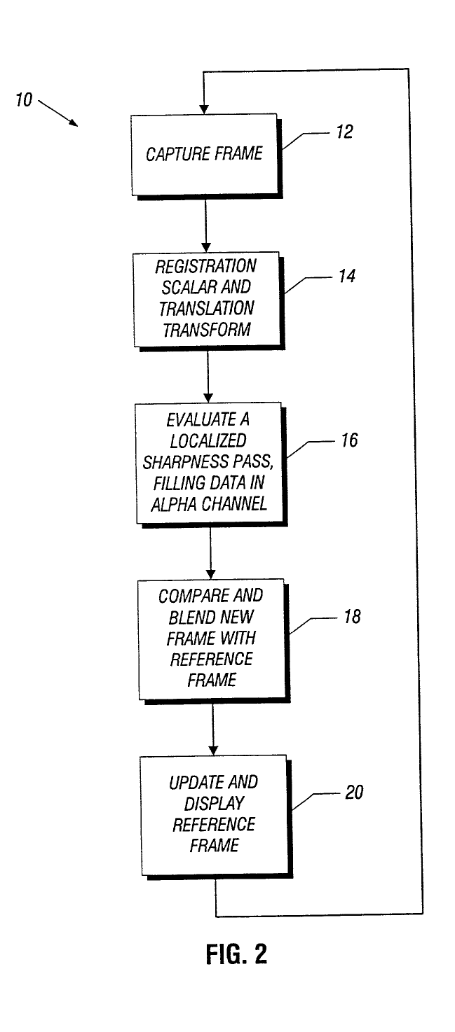

Turning to FIG. 2, in accordance with one embodiment of the present invention, the flow 10 may be implemented by software or hardware. Initially, the imaging device 36 captures a current frame. The flow 10 cycles through each current frame and updates an existing reference frame that contains the accumulated image information from previous frames, as indicated in block 12. The current frame is then transformed to be a scalar, rotational, and translational equivalent of the reference frame, as indicated in block 14. Thus, images from different focal planes may be correlated despite the difference in focal lengths. The current frame may need to be adjusted in terms of its size, brightness, keystoning, color, contrast and orientation for example, to be consistent with the reference frame.

The current and reference frames may have different focal lengths. A variety of images of different focal lengths may be captured either from manual focusing through different focal lengths, or by an automated process wherein a digital imaging device 36 automatically scans through different focal lengths.

The transformed current frame is then analyzed to determine its sharpness on a pixel-by-pixel basis in one embodiment. The sharpness information may be stored in the alpha channel, as indicated in block 16. The alpha channel is a channel separate from the channels that contain red, blue and green (or other color space) information. The alpha channel information may specify the sharpness on a sliding reference scale, for example, by assigning a sharpness value of from 0 to 255.

Using the alpha values, the current frame is then compared with the reference frame, as indicated in block 18. The reference frame is then updated based on the relative alpha values of the reference and current frames. This updated reference frame now contains an image with an increased depth of field. The reference frame can now be displayed to the end user, or stored to some medium as an entirely focused image. The reference frame may also include historical data to ensure that stale data expires. In one embodiment, a stream of live video images is fed into the algorithm. This live feed gradually refines the accuracy of the reference frame.

Generally, the higher the sharpness value the more a pixel is weighted in the resulting adjusted reference frame. Thus, pixels from either a current or reference frame are weighted more heavily the better their focus. The updated reference frame may then be displayed as indicated in block 20.

In some embodiments, the algorithm indicated in FIG. 2 may occur in a real time basis. In other embodiments, a non-real time solution may also be readily accomplished.

In this way in-focus pixels are weighted more heavily in generating the updated reference frame. As a result, image portions that are in focus, taken at different focal lengths, are effectively added on to the reference frame. Pixels with alpha values indicating poorer focus are dominated by pixels having better focus indicating alpha values.

If the imaging device 36 is moved during focusing, a stitching or mosaicing algorithm can be used to compensate for movement. Also, a heavily modified background segmentation algorithm may be used to aid in constructing images that include objects that are actually moving.

Referring to FIG. 3, a processor-based system 22 may include a processor 24 coupled to a bridge 30. The bridge 30 may be coupled to a memory controller 26 and a memory 28.

The bridge 30, in some embodiments, may also be coupled to a bus 32. The bus 32 may be coupled via an interface 34 to the digital camera or other imaging device 36. The bus 32 may also be coupled to a bridge 38, which couples to a hard disk drive 40 that stores software 10. The bridge 38 may also be coupled to a legacy bus 42 in some embodiments.

In some embodiments, images having in-focus objects at different focal lengths may be constructed without using a priori data such as actual focal length information as actual focal length information or other directly obtained lens characteristics. In some embodiments, an iterative approach simplifies the image generation algorithm.

While the architecture depicted in FIG. 3 is for purposes of an example only, the present invention is applicable to a wide range of different architectures of processor-based systems. The processor-based system 22 may be a camera, a microscope, or any other imaging device. Likewise, the system 22 may include a personal computer coupled to a digital imaging device such as a camera in other embodiments.

While an embodiment is described with at least two different focal lengths, in some embodiments, images at any number of different focal lengths may be captured and particularly focused.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
focusing an imaging device over at least two different focal lengths; and
forming an in-focus image including objects at two different focal lengths.

2. The method of claim 1 including automatically focusing an imaging device to at least two different focal lengths.

3. The method of claim 1 including enabling the user to manually adjust the imaging device to at least two different focal lengths.

4. The method of claim 1 wherein forming an in-focus image includes evaluating the sharpness of portions of images taken at two different focal lengths.

5. The method of claim 4 including evaluating sharpness on a pixel-by-pixel basis.

6. The method of claim 5 including evaluating sharpness on a pixel-by-pixel basis and storing sharpness information in an alpha channel associated with each pixel.

7. The method of claim 4 including comparing the sharpness values of two captured frames and weighting pixels having sharpness values indicating better focus more than pixels having sharpness values indicating poorer focus.

8. The method of claim 7 including generating a composite image containing image portions taken over at least two different focal lengths by comparing the quality of focus of two different image portions and weighting the image portion with better focus.

9. The method of claim 1 including transforming a subsequent frame to match the characteristics of a previous frame taken at a different focal length.

10. The method of claim 9 including transforming the size of one of two frames taken at different focal lengths.

11. An article comprising a medium storing instructions that enable a processor-based system to:
focus an imaging device over at least two different focal lengths; and
form an in-focus image to include objects at two different focal lengths.

12. The article of claim 11 further storing instructions that enable a processor-based system to automatically focus an imaging device to at least two different focal lengths.

13. The article of claim 11 further storing instructions that enable a processor-based system to enable the user to manually adjust the imaging device to at least two different focal lengths.

14. The article of claim 11 further storing instructions that enable a processor-based system to evaluate the sharpness of portions of images taken at two different focal lengths.

15. The article of claim 14 further storing instructions that enable a processor-based system to evaluate sharpness on a pixel-by-pixel basis.

16. The article of claim 15 further storing instructions that enable a processor-based system to evaluate sharpness on a pixel-by-pixel basis and store sharpness information in an alpha channel associated with each pixel.

17. The article of claim 14 further storing instructions that enable a processor-based system to compare the sharpness values of two captured frames and weight pixels having sharpness values indicating better focus more than pixels that have sharpness values indicating poorer focus.

18. The article of claim 17 further storing instructions that enable a processor-based system to generate a composite image containing image portions taken over at least two different focal lengths by comparing the quality of focus of two different image portions and weighting the image portion with better focus.

19. The article of claim 11 further storing instructions that enable a processor-based system to transform a subsequent frame to match the characteristics of a previous frame taken at a different focal length.

20. The article of claim 19 further storing instructions that enable a processor-based system to transform the size of one of two frames taken at different focal lengths.

21. A system comprising:
an imaging device; and
a controller to focus the imaging device over at least two different focal lengths and form an in-focus image including objects at two different focal lengths.

22. The system of claim 21 wherein said controller automatically focuses the imaging device to at least two different focal lengths.

23. The system of claim 21 wherein said controller accepts manual focal adjustments to the imaging device to at least two different focal lengths.

24. The system of claim 21 wherein said controller evaluates the sharpness of portions of images taken at two different focal lengths.

25. The system of claim 24 wherein said controller evaluates sharpness on a pixel-by-pixel basis.

26. The system of claim 25 wherein said controller evaluates sharpness on a pixel-by-pixel basis and stores sharpness information in the alpha channel associated with each pixel.

27. The system of claim 24 wherein said controller compares sharpness values of two captured frames and weights pixels having sharpness values indicating better focus more than pixels that have sharpness values indicating poorer focus.

28. The system of claim 27 wherein said controller generates a composite image containing image portions taken over at least two different focal lengths by comparing the quality of focus of two different image portions and weighting the image portion with better focus.

29. The system of claim 21 wherein said controller transforms a subsequent frame to match the characteristics of a previous frame taken at a different focal length.

30. The system of claim 29 wherein said controller transforms the size of one of two frames taken at different focal lengths.
